(19) United States
(12) Patent Application Publication
(10) Pub. No.: US 2026/0111196 A1
(43) Pub. Date: Apr. 23, 2026

(54) VISUALIZING EXECUTED PATHS IN WORKFLOWS USING HIGHLIGHTED PATH REPRESENTATIONS IN A TIERED SOFTWARE FRAMEWORK

(71) Applicant: HighLevel Inc., Dallas, TX (US)

(72) Inventors: Sarvesh Manoj Warge, Navi Mumbai (IN); Arnav Choudhary, Noida (IN); Baibhab Mondal, Bardhaman (IN); Shanjay Nithiin B, Chennai (IN); Prasoon Dadhich, Udaipur (IN); Abhishek Chauhan, Pune (IN); Shaun Clark, Eugene, OR (US); Robin Alex, Dallas, TX (US); Varun Vairavan, Doha (QA)

(73) Assignee: HighLevel Inc., Dallas, TX (US)

(21) Appl. No.: 19/330,950

(22) Filed: Sep. 17, 2025

Related U.S. Application Data
(60) Provisional application No. 63/709,597, filed on Oct. 21, 2024.

(51) Int. Cl. G06F 8/41; G06F 40/284

(52) U.S. Cl. CPC G06F 8/427; G06F 8/433; G06F 40/284

(57) ABSTRACT

In a workflow visualizer, instructions are received from a first user interface in a first computing device to visualize an instance of a published workflow that at least partially competed execution. The instructions are received at a second computing device. An execution log library is searched for an execution log having a unique execution identifier of the executed instance. Responsive to finding the execution log, step identifiers of the individual steps are extracted from the execution log and stored in an array. A second user interface is initiated in the first computing device; and the instance of the workflow is automatically rendered in the second user interface as a color-coded graph highlighting an executed path of the instance against unexecuted nodes and edges of the workflow.

### CROSS REFERENCE TO RELATED APPLICATIONS

This Application claims the benefit of priority to U.S. Provisional Patent Application Ser. No. 63/709,597 filed on Oct. 21, 2024, entitled VISUALIZING EXECUTED PATHS IN WORKFLOWS USING HIGHLIGHTED PATH REPRESENTATIONS IN A TIERED SOFTWARE FRAMEWORK. The disclosure of the prior application is considered part of and is hereby incorporated by reference in its entirety in the disclosure of this Application.

### BACKGROUND

Low-code and no-code software applications are transformative tools that allow users to create and customize digital solutions without any programming knowledge. By utilizing intuitive drag-and-drop interfaces and pre-built templates, these platforms enable individuals and teams to streamline tasks, enhance productivity, and integrate various applications seamlessly. This democratization of technology allows non-technical users to design and implement solutions tailored to their specific needs, fostering creativity and efficiency in business operations. As organizations increasingly embrace digital transformation, low-code and no-code software play a crucial role in accelerating development cycles and reducing reliance on computing resources.

### BRIEF DESCRIPTION OF DRAWINGS

Embodiments will be readily understood by the following detailed description in conjunction with the accompanying drawings. To facilitate this description, like reference numerals designate like elements. Embodiments are illustrated by way of example, and not by way of limitation, in the figures of the accompanying drawings.

FIG. 1 is a simplified block diagram illustrating an example system for visualizing workflows in a tiered software framework.

FIG. 2 is a simplified block diagram illustrating details of an example system for visualizing workflows in a tiered software framework.

FIG. 3 is a simplified block diagram illustrating other details of an example system for visualizing workflows in a tiered software framework.

FIG. 4 is a simplified diagram illustrating other details of an example system for visualizing workflows in a tiered software framework.

FIGS. 5A-5C are simplified diagrams illustrating other details of an example system for visualizing workflows in a tiered software framework.

FIGS. 6A-6D are simplified diagrams illustrating other details of an example system for visualizing workflows in a tiered software framework.

FIG. 7 is a simplified flow diagram illustrating an example method for visualizing workflows in a tiered software framework.

FIG. 8 is a simplified flow diagram illustrating another example method for visualizing workflows in a tiered software framework.

FIGS. 9A-9B are simplified flow diagrams illustrating another example method for visualizing workflows in a tiered software framework.

### DESCRIPTION

For purposes of illustrating the embodiments described herein, it is important to understand certain terminology and operations of technology networks. The following foundational information may be viewed as a basis from which the present disclosure may be properly explained. Such information is offered for purposes of explanation only and, accordingly, should not be construed in any way to limit the broad scope of the present disclosure and its potential applications.

Workflow builders have evolved as a response to the growing need for businesses to automate processes, streamline operations, and improve efficiency. Traditionally, creating workflows involved complex coding and a deep understanding of programming languages, which limited access to technical experts and developers. As organizations recognized the need for agility and rapid adaptability in their operations, the demand for simpler, more accessible solutions emerged. With advancements in user interface design and the increasing prevalence of cloud computing, developers began to create platforms that allowed users to visually map out processes using intuitive drag-and-drop tools. In no-code software development, instead of relying on syntax and manual coding, users interact with visual interfaces, drag-and-drop components, and pre-built logic to define how their application behaves. No-code platforms provide modular building blocks, such as data models, user interface components, automation tools, and integrations with other services, all configurable through simple settings or visual flows. These no-code solutions democratized the process of workflow creation, enabling non-technical users to automate tasks and integrate various applications without writing a single line of code.

The rise of no-code workflow builders coincided with the broader trend of digital transformation, where organizations sought to leverage technology for operational efficiency. As businesses increasingly embraced automation, no-code platforms gained traction, allowing users to quickly prototype, iterate, and implement workflows tailored to their specific needs. This shift not only accelerated innovation but also empowered a new generation of users to take charge of their processes, fostering a culture of agility and continuous improvement within organizations.

Low-code software development is another approach that combines visual development tools of no-code with the ability to write minimal, custom code to build applications more efficiently. Unlike no-code platforms, which aim to eliminate coding altogether, low-code platforms strike a balance by allowing developers to use drag-and-drop interfaces for most of the application logic while still offering the flexibility to insert custom code where needed, such as for advanced integrations, complex business rules, or performance optimizations.

Currently available workflow builders such as Hubspot™, Microsoft Power Automate™, Trello™, Monday. com™, Mailchimp™, etc. provide various types of functionalities and flows for no-code or low-code workflow builders. Examples include: build automated workflows for customer relationship management based on user behavior and interactions; connect and automate tasks between many applications based on trigger events; create workflows with conditional logic and integrations across numerous applications; build custom workflows to manage projects; create automated workflows between proprietary applications and other services; automate repetitive tasks within boards; link databases and task management systems; create custom workflows using a custom interface; create custom tools for modifying workflows; and others. The market continues to grow, with many platforms adding features such as artificial intelligence (AI) integration, enhanced collaboration tools, and better user experiences. This evolution reflects the increasing demand for accessible automation solutions across industries, enabling organizations of all sizes to enhance productivity and efficiency.

Some no code workflows can be complicated, with many conditional branches with complex routing. Troubleshooting any errors after deployment can be an enormous challenge in such complex workflows. While data logs can provide some assistance, visual debugging can be more intuitive. Some such visual debuggers allow developers to pause the execution of a workflow at specific steps. This helps in examining the state and values of variables at those points. Developers can set and remove breakpoints effortlessly through the visual interface. The visual debugger can enable step-by-step execution of workflows and the impact of each step can be observed visually to aid in identifying the exact location of errors or issues. Some such visual debuggers can provide a real-time view of variable states. Changes in variable values can be monitored as the execution progresses. Some visual debuggers enable call stack visualization, displaying the sequence of function calls leading to the current point of execution. Such call stack visualization can help in understanding how the current state was reached, enabling developers to understand how the current state was reached, and navigating through the call stack to analyze the execution flow. These visual debuggers are primarily for identifying and fixing logic errors or bugs within the workflow during testing or development. They are used during workflow creation or modification to troubleshoot issues in real time by stepping through workflow logic and simulating different paths that an end-user (e.g., prospect, potential customer, etc.) could take.

None of these available tools visualize an executing or executed path of a workflow in the context of the entire workflow. In other words, assume that a workflow contains a number of different conditions and corresponding paths.

During execution, only one of the conditions is true, forcing the execution to proceed along that particular conditional path. Currently available visualizers display only the executed conditional path in the workflow graph, leaving out the unexecuted paths from the graph. In complex workflows with myriad conditions, leaving out the information about the unexecuted path can starkly decrease the efficiency of troubleshooting as the unexecuted paths provide crucial information on the alternative conditions that were not met during execution. The engineer tasked with determining what paths were not executed must manually cross-check each executed visualized path with the workflow data to identify the unexecuted paths.

Additionally, none of the available tools address the problem of troubleshooting an error encountered by the end-user who is using or has used a published (i.e., released) workflow. In such a situation, it may be desirable to understand the actual path taken by the end-user vis-à-vis the unexecuted paths and the actual error encountered in the workflow after the fact (for example, not in real time). The current visual debuggers can only provide a means to facilitate the software tester to test the logic of the workflow before it is published; while they can visualize potential paths or errors by stepping through the logic in real time, they cannot facilitate visualizing an actual path after it has been executed in the field.

Accordingly, embodiments of a workflow path visualizer in a tiered software framework provide a system and method for highlighting a path taken by an end-user in a published workflow for ease of troubleshooting subsequently by a software tester, field application engineer, customer support technician, or other such user. The method enables path analysis and visualization of past behavior. In some embodiments, when the user clicks a “view execution path” button on the no code application interface, the user is rerouted to a path with a workflow identifier and an execution identifier in a uniform resource locator (URL). Workflow execution logs are fetched using the execution identifier and corresponding workflow data is fetched using the workflow identifier. Step identifiers (i.e., Identifiers of individual steps executed and completed in the workflow for the end-user) are extracted and saved in an array. Thereafter, the workflow is rendered in the user interface using a tree rendering algorithm of the workflow builder; during the rendering, the nodes and branches in the particular path completed by the end-user is highlighted using various conditions. For example, if a current node is present in the array, the node is highlighted. If the step identifier's status indicates an error, the relevant node is highlighted in red, otherwise it is highlighted in green. If the current node and child node are both present in the array then the branch between them is highlighted. Edge cases of branch/conditional nodes of the tree are handled by checking all the children of the current node. “Goto” operations are handled separately by highlighting source and target nodes and the relevant goto branch.

In various embodiments, the same tree rendering algorithm that is used to render the workflow during development can be used to visualize the executed path after the workflow has been released; the tree rendering algorithm is modified suitably to highlight the executed path in the original workflow in one go. In many embodiments, unlike typical visual debuggers used during development, in which the logic is studied node by node or branch by branch by stopping and analyzing the workflow, the system and methods disclosed in the various embodiments herein facilitate visualizing the path of the end-user completed during execution within the entire workflow in one step or rendering operation. In the following detailed description, various aspects of the illustrative implementations may be described using terms commonly employed by those skilled in the art to convey the substance of their work to others skilled in the art.

The term “coupled” means either a direct connection between the things that are connected, or an indirect connection through one or more passive or active intermediary devices.

The term “computing device” means a server, a desktop computer, a laptop computer, a smartphone, or any device with a microprocessor, such as a central processing unit (CPU), general processing unit (GPU), or other such electronic component capable of executing processes of a software algorithm (such as a software program, code, application, macro, etc.).

The term “cloud network” or simply “cloud” means a network of computing devices coupled together in a public, private, or hybrid communications network. Communication in the cloud network may use one or more wired, wireless, broadband, radio, and other kinds of communicative means. The Internet is an example of a cloud network.

The term “application” can be inclusive of an executable file comprising instructions that can be understood and processed on a computing device such as a computer, and may further include library modules loaded during execution, object files, system files, hardware logic, software logic, or any other executable modules. Applications are generally configured to perform particular tasks, or functions according to the type of application.

The description uses the phrases “in an example” or “in examples,” which may each refer to one or more of the same or different examples.

Although certain elements may be referred to in the singular herein, such elements may include multiple sub-elements. For example, “a computing device”may include one or more computing devices.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

In the following detailed description, reference is made to the accompanying drawings that form a part hereof, and in which is shown, by way of illustration, examples that may be practiced. It is to be understood that other examples may be utilized, and structural or logical changes may be made without departing from the scope of the present disclosure. Therefore, the following detailed description is not to be taken in a limiting sense.

The accompanying drawings are not necessarily drawn to scale. In the drawings, same reference numerals refer to the same or analogous elements shown so that, unless stated otherwise, explanations of an element with a given reference numeral provided in context of one of the drawings are applicable to other drawings where element with the same reference numerals may be illustrated. Further, the singular and plural forms of the labels may be used with reference numerals to denote a single one and multiple ones respectively of the same or analogous type, species, or class of element.

Note that in the figures, various components are shown as aligned, adjacent, or physically proximate merely for ease of illustration; in actuality, some or all of them may be spatially distant from each other. In addition, there may be other components, such as routers, switches, antennas, communication devices, etc. in the networks disclosed that are not shown in the figures to prevent cluttering. Systems and networks described herein may include, in addition to the elements described, other components and services, including network management and access software, connectivity services, routing services, firewall services, load balancing services, content delivery networks, virtual private networks, etc. Further, the figures are intended to show relative arrangements of the components within their systems, and, in general, such systems may include other components that are not illustrated (e.g., various electronic components related to communications functionality, electrical connectivity, etc.).

In the drawings, a particular number and arrangement of structures and components are presented for illustrative purposes and any desired number or arrangement of such structures and components may be present in various examples. Further, unless otherwise specified, the structures shown in the figures may take any suitable form or shape according to various design considerations, manufacturing processes, and other criteria beyond the scope of the present disclosure.

For convenience, if a collection of drawings designated with different letters are present, such a collection may be referred to herein without the letters. Similarly, if a collection of reference numerals designated with different letters are present (e.g., 106a, 106b), such a collection may be referred to herein without the letters (e.g., as “106”) and individual ones in the collection may be referred to herein with the letters. Further, labels in upper case in the figures (e.g., 106A) may be written using lower case in the description herein (e.g., 106a) and should be construed as referring to the same elements.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described examples. Various additional operations may be performed, and/or described operations may be omitted in additional examples.

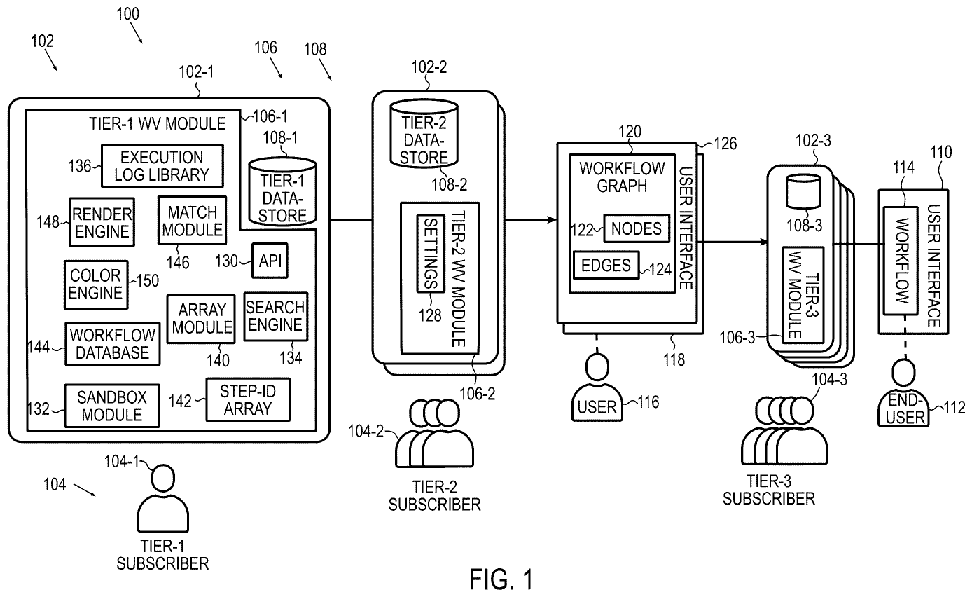

FIG. 1 is a simplified block diagram illustrating an example workflow visualizer 100 for visualizing workflows in a tiered software framework. Workflow visualizer 100 comprises various tiers 102. In the example shown, three tiers are shows, namely first tier 102-1, second tier 102-2 and third tier 102-3. Note that the labeling convention followed herein uses the hyphen followed by a number to denote a separate tier corresponding to the number (e.g., “-1” denotes the first tier, “-2” denotes the second tier, and “-3” denotes the third tier). Tiers 102 are accessed by subscribers 104 according to access credentials based on their respective tiers 102. For example, first-tier subscribers 104-1 have access to first tier 102-1, second tier 102-2, and third tier 102-3; second-tier subscribers 104-2 have access to second tier 102-2 and third tier 102-3; and third-tier subscribers 104-3 have access only to third tier 102-3.

Tiers 102 may be organized according to a hierarchy of management (i.e., to oversee, to control, to maintain), with upstream tiers managing downstream ones. Thus, first tier 102-1 comprises operations that may manage second tier 102-2 and third tier 102-3, whereas second tier 102-2 comprises operations that may manage third tier 102-3 but not first tier 102-1. For purposes of terminology, first tier 102-1 is “upstream” relative to second tier 102-2 and third tier 102-3; third tier 102-3 is “downstream” relative to second tier 102-2 and first tier 102-1; second tier 102-2 is downstream relative to first tier 102-1 and upstream relative to third tier 102-3. In some examples, each tier 102 may interact with the tier immediately adjacent thereto (e.g., downstream or upstream) but not with non-adjacent tiers.

Workflow visualizer 100 may be managed by one of first-tier subscribers 104-1 providing one or more downstream second-tier subscribers 104-2 with access to certain functionalities of workflow visualizer 100. In turn, any one of second-tier subscribers 104-2 may provide one or more downstream third-tier subscribers 104-3 with access to certain other functionalities of workflow visualizer 100. In various examples, the functionalities available to first-tier subscribers 104-1 may not be the same as those available to second-tier subscribers 104-2, which may be different from those available to third-tier subscribers 104-3. In one example, functionalities available to third-tier subscribers 104-3 may be a subset of functionalities available to second-tier subscribers 104-2.

Subscribers 104 (e.g., 104-1, 104-2 and 104-2) may include an entity (i.e., a company, an organization, etc.) in various examples. In an example, first-tier subscribers 104-1 may be software-as-a-service (SaaS) providers, second-tier subscribers 104-2 may comprise marketing agencies, and third-tier subscribers 104-3 may comprise individual businesses, such as plumbers, dentists, pet stores, etc. In some examples in which second-tier subscribers 104-2 are marketing agencies, that they are interchangeably referred to herein as “agency” or “agencies. ” In some examples in which third-tier subscribers 104-3 are businesses trying to market their brands, they are interchangeably referred to herein as “brand” or “brands. ” Agencies may provide services for one or more brands, whereas each brand is typically separate from other brands.

Human users at subscribers 104 may operate or otherwise use workflow visualizer 100 through one or more computing devices such as computers, laptops, smartphones, mobile computing devices, mobile phones, iPads™, Google Droids™, Microsoft® Surface™, etc. In various examples, a single one of first-tier subscribers 104-1 may have multiple second-tier subscribers 104-2; a single one of second-tier subscribers 104-2 may have multiple third-tier subscribers 104-3. Each one of second-tier subscribers 104-2 may have an account with one of first-tier subscribers 104-1; each one of third-tier subscribers 104-3 may have an account with one of second-tier subscribers 104-2. In other words, there may be a one-to-many relationship downstream (e.g., from first tier 102-1 to second tier 102-2 to third tier 102-3), and a one-to-one relationship upstream (e.g., from third tier 102-3 to second tier 102-2 to first tier 102-1).

In various examples, workflow visualizer 100 includes a workflow visualizer module 106 (WV module) executing at three tiers: first-tier WV module 106-1; second-tier WV module 106-2; and third-tier WV module 106-3. In some examples, third-tier WV module 106-3 is substantially identical to second-tier WV module 106-2. In some other examples, third-tier WV module 106-3 may have a subset of functionalities of second-tier WV module 106-2. A data store 108 operates at tiers 102 as follows: a first-tier data store 108-1 includes all data in workflow visualizer 100 accessible at first tier 102-1 to a particular one of first-tier subscribers 104-1; a second-tier data store 108-2 includes all data in workflow visualizer 100 accessible at second tier 102-2 to a particular one of second-tier subscribers 104-2; a third-tier data store 108-3 includes all data in workflow visualizer 100 accessible at third tier 102-3 to a particular one of third-tier subscribers 104-3. Each one of subscribers 104 has access to data store 108 at their particular tier 102 and their account.

Third tier 102-3 includes a user interface 110 using which an end-user 112 executes a workflow 114. The term “workflow” refers to a defined sequence of actions (e.g., operations, processes, steps, tasks, etc.) that are carried out automatically to complete a specific functionality of an application. Workflow 114 includes a start point (e.g., trigger such as user input, form submission, etc.), a sequence of actions, a decision logic (e.g., conditional paths or rules that determine how the sequence proceeds), actors (e.g., software modules that execute functions of the actions) and an end point that completes workflow 114. In various examples, workflow 114 is represented in workflow visualizer 100 as a structured or unstructured data container identified by a unique workflow identifier. The workflow data container comprises nodes identified by respective unique step identifiers, edges representing dependencies between the nodes, and metadata representing conditions, parallelism, retry policies, etc. that affect execution of the nodes. In some examples, end-user 112 executes a particular path (i.e., sequence of actions according to a decision logic) of workflow 114 from start to finish as per configurations of workflow 114. In some other examples, end-user 112 executes the particular path of workflow 114 partially, exiting before the finish is reached.

Thereafter, another user 116 (e.g., software tester, field application engineer, customer support technician, etc.) using a user interface 118 requests visualization of the particular path executed by end-user 112. In some examples, user 116 may be the same as end-user 112, as determined by the respective access credentials of user 116 and end-user 112. In some examples, user interface 118 may comprise a different window than user interface 110. In some other examples, user interface 118 may comprise the same window as user interface 110, but accessed by selecting another tab than user interface 110. In some examples, a user interface element, such as a selectable button is provided on user interface 118 to allow user116 to select it suitably. Upon selection, another window may be opened displaying user interface 126 (or alternatively, another view is rendered in the same window showing user interface 126), highlighting the path in workflow 114 that was completed during execution.

In some examples, responsive to receiving the request, workflow graph 120 comprising nodes 122 and edges 124 of workflow 114 is displayed in a user interface 126. Workflow graph 120 comprises a directed graph (e.g., directed acyclic graph (DAG)) in which edges 124 define the execution order of nodes 122. In various examples, the execution path of workflow 114 completed by end-user 112 is simultaneously displayed in workflow graph 120 with other unexecuted paths of the workflow. Such a display enables user 116 to see at a glance the particular conditions that were applicable to the execution path of end-user 112 as compared to other conditions that are possible according to the configuration of workflow 114. In some scenarios, such as during troubleshooting an error, visualizing these alternative conditions can help in diagnosing the error quickly. In other words, workflow visualizer 100 enables an improvement in troubleshooting software related to computer technology.

Second-tier WV module 106-2 stores various settings 128 including user profiles, data access, user interface configurations, etc. In various examples, third-tier WV module 106-3 is substantially identical to second-tier WV module 106-2. Settings 128 are not shown in third tier 102-3 merely to prevent cluttering in the drawing.

First-tier WV module 106-1 comprises an API 130 that orchestrates all aspects of execution of workflow visualizer 100. In various examples, API 130 receives instructions from user interface 118 to visualize the instance of workflow 114 executed by end-user 112, the instance of workflow 114 being identified by a unique execution identifier. Thereupon, API 130 causes a sandbox module 132 to instantiate a sandbox. A search engine 134 is instantiated in the sandbox to search an execution log library 136 for an execution log associated with the unique execution identifier. In various examples, search engine 134 comprises a distributed, RESTful search and analytics engine built execution log library 136. Execution log library 136 facilitates searching using an appropriate coding language, such as Java, Python, C++, etc. In some examples, a commercially available library infrastructure, such as Apache Lucene™, Whoosh™, Xapian™, etc. is used to construct execution log library 136.

Data is stored in execution log library 136 in indexes that comprise logical namespaces of execution logs of instance of workflows that were executed in the tiered software framework. In an example, the execution logs comprise schema-free JSON objects having fields representing the data therein. Examples of data stored in execution logs include the individual steps of workflow 114 that were completed during execution of the respective instances, each step being identified by the step identifier of the corresponding node; the status of each step; the workflow identifier; access credentials of user 112; time at which the step was executed; etc. In one example implementation, each index is partitioned into shards distributed across multiple nodes in a cluster to ensure scalability and fault tolerance.

Execution log library 136 is configured for inverted indexing to facilitate efficient full-text search. When an execution log is ingested into execution log library 136 (e.g., after or during execution of workflow 114), the execution log is indexed using analyzers that tokenize and normalize field content in the execution log to facilitate fast querying. The tokenization/normalization process converts field content into terms that are mapped to the execution log and its location (e.g., specified by a uniform resource locator (URL)). In other words, instead of documents mapped to terms, the terms are mapped to documents in execution log library 136. Search engine 134 expresses queries using a Domain-Specific Language (DSL) that supports complex full-text, structured, and geospatial queries, as well as aggregations for real-time data analytics. In various examples, search engine 134 may query execution log library 136 using one of the tokenized terms (e.g., execution identifier) to find the document quickly. The cluster's coordination layer handles routing, indexing, and query execution, ensuring consistency and performance across distributed nodes.

Responsive to finding the execution log corresponding to the execution of the instance of workflow 114 by 112, the execution log is fetched into the sandbox by an array module 140. Array module 140 extracts the step identifiers of the individual steps from the execution log and stores them in a step-ID array 142 in the sandbox. Storing the step identifiers in step-ID array 142 enables faster parsing and matching for subsequent operations. In the absence of step-ID array 142, execution log library 136 may have to searched for each subsequent operation; as execution log library 136 contains a larger corpus of data, the searching may take longer than searching inside step-ID array 142 only, and may be more prone to errors (e.g., irrelevant search results, failed searches, empty search results, etc.).

In various examples, search engine 134 uses the workflow identifier to search a workflow database 144 for configurations of workflow 114. Workflow database 144 comprises the workflow data containers of workflows generated in the software framework. In some examples, workflow database 144 may be configured for inverted indexing, similar to execution log library 136. In some other examples, workflow database 144 may be another type of database structure, optimized for other types of searching, such as relational databases, hash index database, prefix trees, etc. Responsive to finding the workflow data container corresponding to the version of workflow 114 that was executed, a match module 146 compares the step identifiers of the nodes in the workflow data container against the step identifiers in step-ID array 142. In the absence of step-ID array 142, execution log library 136 may be searched for the combined query of {execution identifier AND step identifier}. The combined query may take longer to compute than searching in step-ID array 142, the latter being more focused and yielding more relevant and accurate results.

User interface 126 is instantiated in the sandbox, and a render engine 148, in coordination with a color engine 150, renders workflow graph 120 in user interface 126 according to the comparison by match module 146. Render engine 148 comprises a graph layout algorithm (e.g., tree rendering algorithm) that determines how the nodes and edges of workflow 114 should be placed visually (e.g., hierarchical top down, force-directed, etc.). In some examples, workflow graph 120 is rendered as a hierarchical top down tree.

For each node in workflow 114, match module 146 parses step-ID array 142 for the corresponding step identifier. Responsive to finding the step identifier in step-ID array 142, color engine 150 assigns the node a first color, and render engine 148 renders the node in the assigned first color in workflow graph 120. Responsive to not finding the step identifier in step-ID array 142, color engine 150 assigns the node a second color different from the first color, and render engine 148 renders the node in the assigned second color in workflow graph 120. Responsive to finding that the status of the step identifier in the workflow execution log indicates an error, color engine 150 assigns the node a third color different from the first color or the second color, and render engine 148 renders the node in the assigned third color in workflow graph 120.

Edges of nodes are handled by finding all child nodes in the workflow data container. Responsive to finding a child node of the node, step-ID array 142 is searched for the child node's step identifier. Responsive to finding the child node's step identifier in step-ID array 142, color engine 150 assigns the first color to the corresponding edge between the node and the child node, and render engine 148 renders the edge in the assigned first color in workflow graph 120. Responsive to identifying a discontinuity in workflow 114 represented by a “go to” condition for the node, array module 140 identifies a destination node of the discontinuity in the workflow data container. If the destination node's step identifier is present in step-ID array 142, the destination node and the associated edge are assigned the first color by color engine 150. On the other hand, if the destination node's step identifier is not present in step-ID array 142, the destination node and the associated edge are assigned the second color by color engine 150. If the destination node's status indicates error, the destination node is assigned the third color by color engine 150 and the associated edge is assigned the first color. Thereupon, render engine 148 renders workflow graph 120 with the node, the destination node and the associated edge in the appropriate colors.

In various examples, each node in workflow graph 120 is rendered to display its step identifier, its name (e.g., label as specified in the workflow data container of workflow 114), and the execution status (e.g., success, failed, running, not executed, etc.) In some other examples, the execution status is not specified in text, and is instead determinable by the rendered color. In some examples, workflow graph 120 is rendered so that user 116 can interact with each node and edge, for example, clicking on a node to open a pop-up window specifying additional details of the node extracted from the workflow data container of workflow 114. In some examples, user interface 126 displays a scrollable window allowing user 116 to scroll up or down, or right or left, to view the entire highlighted path within the entirety of workflow 114, including the unexecuted paths.

In some embodiments, the first color is green, the second color is black and the third color is red, so that errors are rendered in red and executed steps and edges without errors are rendered in green, whereas unexecuted nodes and edges are rendered in black. Various other colors and visual elements may be used within the broad scope of the embodiments to highlight the path taken by the prospect in the published workflow.

In some examples, user 116 may be at any one of tiers 102 without departing from the scope of the embodiments. User interface 118 and user interface 126 may be provided at any tier 102. The execution logs may be stored at third tier 102-3 in some examples and accessed by user 116 at the appropriate tier suitably. In some examples, execution log library 136 may be distributed across all accounts in third tier 102-3, separated by data access policies of each tier, so that the execution logs are accessible only to those with the correct access credentials according to the tiered data hierarchy of the software framework. In some embodiments, user 116 may be at second tier 102-2 and may have access to multiple sub-accounts at third tier 102-3. Errors encountered by multiple end-users 112 at multiple sub-accounts may be visualized appropriately in the same workflow 114 in some embodiments, by extracting multiple execution logs from execution log library 136. In such embodiments, the execution paths of each execution instance identified by corresponding execution identifiers, are differentiated from each other by color or other visual element in workflow graph 120. For example, the execution path of one end-user 112 is rendered in blue whereas the execution path of another end-user 112 is rendered in green, and the execution path of yet another end-user 112 is rendered in purple, and so on. These different execution paths are rendered in a common workflow graph 120 showing other unexecuted paths, for example, in black. In some other examples, the execution path of only one execution instance may be displayed at a time. Various such configurations may be provided without departing from the scope of the embodiments.

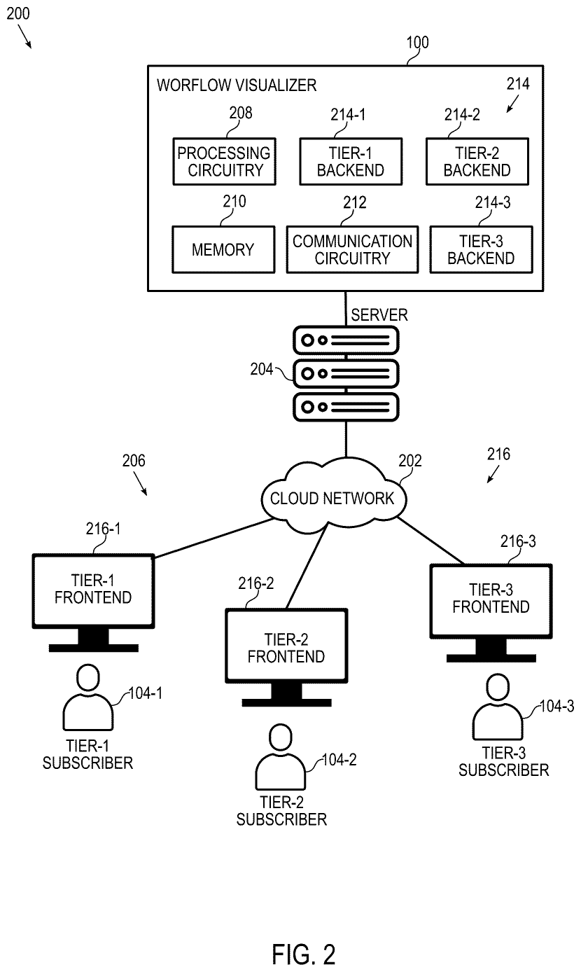

FIG. 2 is a simplified block diagram illustrating a tiered software framework 200 according to various embodiments. In example implementations, at least some portions of the activities outlined herein may be hosted on a cloud network 202 in one or more servers 204. At least some other portions of the activities outlined herein may be implemented in one or more computing devices 206 connected over one or more communication networks with cloud network 202. In particular embodiments, cloud network 202 is a collection of hardware devices and executable software forming a shared pool of configurable computing resources (e.g., networks, servers, storage, applications, services, etc.) that may be suitably provisioned to provide on-demand self-service, network access, resource pooling, elasticity and measured service, among other features. Computing device 206 may have any desired form factor, such as a handheld or mobile computing device (e.g., a cell phone, a smart phone, a mobile Internet device, a tablet computer, a laptop computer, a netbook computer, an ultra-book computer, a Personal Digital Assistant (PDA), an ultramobile personal computer, etc.), a desktop computing device, a server or other networked computing component, a set-top box, an entertainment control unit, or a wearable computing device.

Certain portions of tiered software framework 200 (e.g., workflow visualizer 100) may execute using a processing circuitry 208, a memory 210 and communication circuitry 212 (among other components) in one or more servers 204. Certain other portions of tiered software framework 200 may execute in one or more computing devices 206 using respective processing circuitry, memory, and communication circuitry (not shown with particularity so as not to clutter the drawing) substantially similar in functionalities to processing circuitry 208, memory 210 and communication circuitry 212. In some embodiments, one or more of these features may be implemented in hardware, provided external to these elements, or consolidated in any appropriate manner to achieve the intended functionality. The various network elements in tiered software framework 200 may include communication software that can coordinate to achieve the operations as outlined herein. In still other embodiments, these elements may include any suitable algorithms, hardware, software, components, modules, interfaces, or objects that facilitate the operations thereof.

Processing circuitry 208 may execute any type of instructions associated with data stored in memory 210 to achieve the operations detailed herein. In one example, processing circuitry 208 may transform data from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., field programmable gate array (FPGA), an erasable programmable read only memory (EPROM), an application specific integrated circuit (ASIC)) that includes digital logic, software, code, electronic instructions, flash memory, optical disks, magnetic or optical cards, other types of machine-readable mediums suitable for storing electronic instructions, or any suitable combination thereof.

In some of example embodiments, one or more memory 210 may store data used for the operations described herein. This includes memory 210 storing instructions (e.g., software, logic, code, etc.) in non-transitory media (e.g., random access memory (RAM), read only memory (ROM), FPGA, EPROM, etc.) such that the instructions are executed to carry out the activities described in this disclosure based on particular needs. In some embodiments, memory 210 may comprise non-transitory computer-readable media, including one or more memory devices such as volatile memory such as dynamic RAM (DRAM), nonvolatile memory (e.g., ROM), flash memory, solid-state memory, and/or a hard drive. In some embodiments, memory 210 may share a die with processing circuitry 208. Memory 210 may include algorithms, code, software modules, and applications, which may be executed by processing circuitry 208. The data being tracked, sent, received, or stored in tiered software framework 200 may be provided in any database, register, table, cache, queue, control list, or storage structure, based on particular needs and implementations, all of which could be referenced in any suitable timeframe.

Communication circuitry 212 may be configured for managing wired or wireless communications for the transfer of data in tiered software framework 200. The term “wireless” and its derivatives may be used to describe circuits, devices, systems, methods, techniques, communications channels, etc., that may communicate data through modulated electromagnetic radiation in a nonsolid medium. The term does not imply that the associated devices do not contain any wires, although in some embodiments they might not.

Communication circuitry 212 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long Term Evolution (LTE) project along with any amendments, updates, and/or revisions (e.g., advanced LTE project, ultramobile broadband (UMB) project (also referred to as “3GPP2”), etc.). Communication circuitry 212 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. Communication circuitry 212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication circuitry 212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication circuitry 212 may operate in accordance with other wireless protocols in other embodiments. Communication circuitry 212 may include antennas to facilitate wireless communications and/or to receive other wireless communications.

In some embodiments, communication circuitry 212 may manage wired communications, such as electrical, optical, or any other suitable communication protocols (e.g., the Ethernet, Internet). Communication circuitry 212 may include multiple communication chips. For instance, a first communication chip may be dedicated to shorter-range wireless communications such as Wi-Fi or Bluetooth, and a second communication chip may be dedicated to longer-range wireless communications such as global positioning system (GPS), EDGE, GPRS, CDMA, WiMAX, LTE, EV-DO, or others. In some embodiments, a first communication chip may be dedicated to wireless communications, and a second communication chip may be dedicated to wired communications.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a WANs (e.g., the Internet).

In various embodiments, tiers 102 may be partitioned into a backend 214 and a frontend 216. Backend 214 may comprise tier-1 backend 214-1, tier-2 backend 214-2, and tier-3 backend 214-3 provisioned in one or more servers 204. Likewise, frontend 216 may comprise tier-1 frontend 216-1, tier-2 frontend 216-2, and tier-3 frontend 216-3 provisioned in one or more computing devices 206. Backend 214 may comprise various modules, logic, software engines and other components that are distributed (and common) across all users of tiered software framework 200. Backend 214 may execute operations for managing and processing data, performing computations, and facilitating communication between different components, such as components of workflow visualizer 100. In particular embodiments, backend 214 may include operations such as data management, business logic of workflow visualizer 100, user authentication and authorization, security and validation, APIs with third-party components such as web crawlers, payment processors, etc.

In a general sense, frontend 216 comprises at least a user interface, including user interface 110, user interface 118 or user interface 126, using which human users interact with tiered software framework 200. Frontend 216 may also include libraries, forms, device integrators and other components as desired and based on particular needs. Frontend 216 may be presented on a suitable display device coupled to computing device 206 and appropriate to show visual indicators, such as a heads-up display, a computer monitor, a projector, a touchscreen display, a liquid crystal display (LCD), a light-emitting diode display, and/or a flat panel display. In various embodiments, frontend 216 may be specific to the particular one of tier 102. For example, frontend 216-1 at first tier 102-1 may comprise certain functionalities available (and visible) only to first-tier subscriber 104-1, e.g., SaaS provider, software developer. Frontend 216-2 at second tier 102-2 may comprise certain functionalities available (and visible) only to second-tier subscriber 104-2. Frontend 216-3 at third tier 102-3 may comprise certain functionalities available (and visible) only to third-tier subscriber 104-3.

Tiered software framework 200 described and shown herein (and/or its associated structures) may also include suitable interfaces for receiving, transmitting, and/or otherwise communicating data or information in a network environment. In a general sense, the arrangements depicted in the figures may be more logical in their representations, whereas a physical architecture may include various permutations, combinations, and/or hybrids of these elements. It is imperative to note that countless possible configurations can be used to achieve the operational objectives outlined here. Accordingly, the associated infrastructure has a myriad of substitute arrangements, design choices, device possibilities, hardware configurations, software implementations, equipment options, etc.

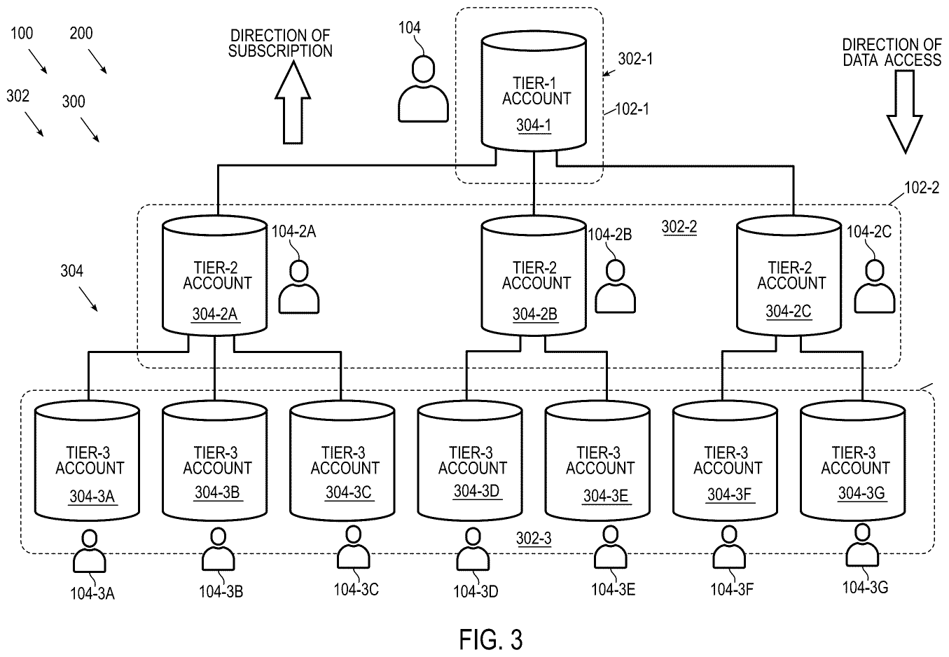

FIG. 3 is a simplified block diagram illustrating example details of data hierarchy 300 of tiered software framework 200 implementing workflow visualizer 100, according to some embodiments of the present disclosure. In various embodiments, data 302 communicated in tiered software framework 200 may be exclusively received from users such as subscriber 104-1 and subscribers 104-2, and 104-3; in some other embodiments, data 302 may also be received from other sources, such as third parties and/or from the Internet. Examples of data 302 include business niche targeted by subscribers 104, marketing activities such as on social media, target audience of subscribers 104, login credentials to access various marketing platforms, frequency of marketing activities, information to be included in the content of marketing posts, customer lists, business locations, marketing platform rules, and other such data relevant to the functionalities offered by tiered software framework 200. Data 302 may be stored in data lakes, databases, data warehouses, blockchains, file systems and other types of data storage facilities within the broad scope of the embodiments with corresponding accessing and viewing capabilities as described herein.

Data 302 in each tier 102 may be contained within accounts 304 accessible and viewable with appropriate access credentials. For example, account 304-1 may be associated with subscriber 104-1. Account 304-1 may manage a plurality of accounts 304-2 at tier 102-2. Subscriber 104-2A may have a subscription to account 304-2A in plurality of accounts 304-2. Account 304-2A may manage a plurality of accounts 304-3 at tier 102-3. Subscriber 104-3A may have a subscription to account 304-3A in plurality of accounts 304-3; subscriber 104-3B may have a subscription to account 304-3B in plurality of accounts 304-3; and subscriber 104-3C may have a subscription to account 304-3C in plurality of accounts 304-3. In other words, subscriber 104-2A has three downstream subscribers at tier 102-3, namely subscribers 104-3A, 104-3B, and 104-3C with their associated respective accounts 304-3A, 304-3B, and 304-3C. Likewise for other accounts shown in the figure. Note that such a framework is merely provided for illustrative purposes and should not be construed as a limitation. Any number of subscribers may be provided at tiers 102-2 and 102-3 in tiered software framework 200 within the broad scope of the embodiments.

In various embodiments, data 302 may be arranged in data hierarchy 300 for different accounts 304 such that certain users can view and access only a subset of data 302 according to their respective tier 102 and access credentials based on particular needs (e.g., user credentials may indicate which tier 102 and which corresponding accounts 304 are available for access and view). Such accounts 304 may be facilitated by a suitable user interface at frontend 216 for viewing the accessible data. Appropriate user authentication and authorization engines running in backend 214 may ensure that accounts 304 are maintained as desired and appropriate privacy blocks are applied at appropriate tiers 102.

In the example illustrated herein, tier-1 data 302-1 may be of account 304-1; tier-2 data 302-2 may be of accounts 304-2A, 304-2B and 304-2C corresponding to subscribers 104-2A, 104-2B and 104-2C, respectively; tier-3 data 302-3 may be of accounts 304-3A . . . 304-3G corresponding to subscribers 104-3A . . . 104-3G. Subscribers 104-3A . . . 104-3G may access and view their own respective accounts 304-3A . . . 304-3G; however, they cannot access or view other accounts 304 in the same tier 102-3 or in upstream tiers 102-2 or 102-1. Note that accessing and viewing an account refers to accessing and viewing the data of the account. Subscribers 104-2A . . . 104-2C at tier 102-3 may access and view their own respective accounts 304-2A . . . 304-2C as well as downstream accounts 304-3 of their respective subscribers 104-3; however, they cannot access or view other accounts 304-2 in the same tier 102-2, or in downstream tier 102-3 not associated with their downstream subscribers 104-3, or in upstream tier 102-1. For example, subscriber 104-2A may access and view accounts 304-2A, 304-3A, 304-3B, and 304-3C; subscriber 104-2B may access and view accounts 304-2B, 304-3D, and 304-3E; subscriber 104-2C may access and view accounts 304-2C, 304-3F, and 304-3G. Subscriber 104-1 at tier 102-1 may access and view accounts 304-1 at tier 102-1, 304-2A . . . 304-2C at tier 102-2, and 304-3A . . . 304-3G at tier 102-3.

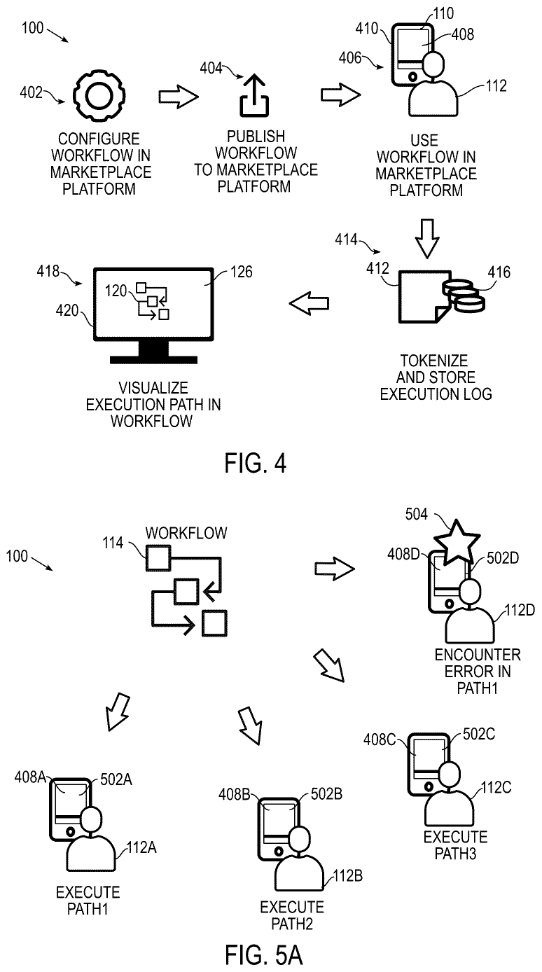

FIG. 4 is a simplified diagram illustrating various operations and systems to visualize workflow 114 in workflow visualizer 100. At 402, workflow 114 is configured in the marketplace platform. At 404, workflow 114 is published to the marketplace platform. The publishing process makes workflow 114 public and available for end-user 112 to use workflow 114. End-user 112 gains access to workflow 114 by receiving it in an email, accessing it on a website, purchasing it, subscribing to it, or by other means beyond the scope of the present disclosure. End-user 112 is a prospect of a third-tier subscriber 104-3 in some examples. In some such examples, the prospect does not have access to the marketplace platform, and uses workflow 114 as a guest user associated with a particular subscriber 104 that enabled access to workflow 114. In some other examples, end-user 112 has access credentials of one of second-tier subscribers 104-2 or third-tier subscribers 104-3.

At 406, end-user 112 executes an instance 408 of workflow 114 in a computing device 410 with user interface 110. For example, as part of the execution of instance 408, certain forms and other user interface elements may appear on user interface 110 in computing device 410. In some examples, computing device 410 comprises a smartphone; in some other examples, computing device 410 comprises a computer. In various examples, computing device 410 may comprise other types of computing devices. End-user 112 may enter data (e.g., name, contact information, etc.) in user interface 110 and interact with instance 408 according to the configurations of workflow 114 set at 402. All such interactions are captured as metadata in an execution log 412. At 414, execution log 412 is tokenized into tokens 416 in execution log library 136. Tokens 416 comprise terms in execution log 412, such as execution identifier, step identifier, status of step, etc. Thereafter, execution log 412 can be found in execution log library 136 by querying one of tokens 416, for example, execution identifier. Because execution log library 136 is configured for inverse indexing, tokens 416 point to the location of execution log 412 in tiered software framework 200. At 418, instance 408 may be visualized as workflow graph 120 in user interface 126 on another computing device 420. In some examples, computing device 420 comprises a smartphone; in some other examples, computing device 420 comprises a computer. In various examples, computing device 420 may comprise other types of computing devices.

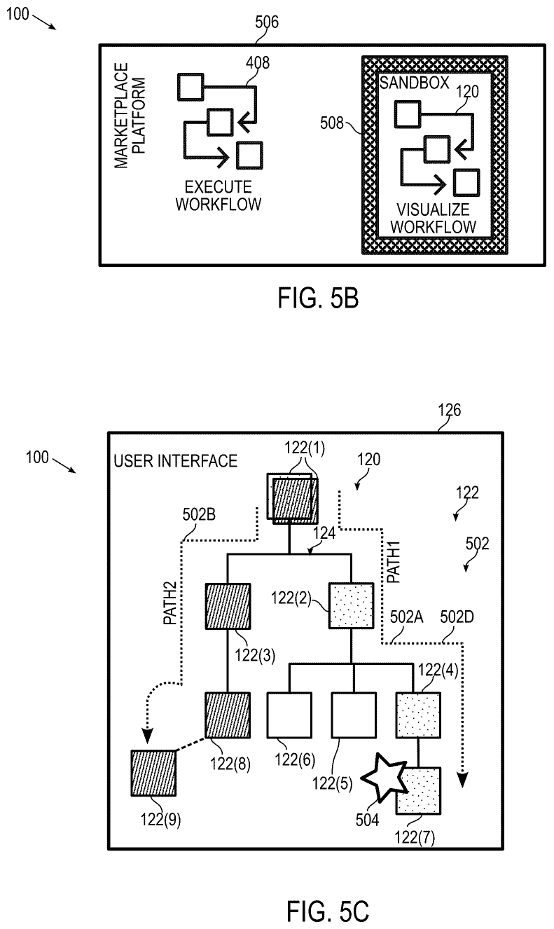

FIGS. 5A-5C are simplified diagrams illustrating various aspects of workflow visualizer 100. Workflow 114 may be used by more than one end-user 112, for example, end-user 112A, end-user 112B, end-user 112C and end-user 112D. Any number of end-users 112 may be included without departing from the scope of the disclosure. Each end-user 112A-112D executes a different instance 408 of workflow 114, for example, 408A, 408B, 408C and 408D, respectively. In addition, each end-user 112A-112D may follow a different execution path 502, for example, 502A, 502B, 502C and 502, respectively. Note that instance 408 may be executed only partially as not all conditional branches of workflow 114 are satisfied simultaneously in one execution instance. In the example shown, execution path 502A and 502D are substantially similar, except that end-user 112D encounters an error 504 during execution. Such may be the case, for example, where the configuration of workflow 114 did not take into account a specific data entry that may be entered by end-user 112 (e.g., email address text input configured to accept only letters, radio button not configured correctly, etc.). According to various examples of workflow visualizer 100 the different execution paths 502 are visualized simultaneously in the same workflow graph 120 as nodes 122 and edges 124, each execution path 502 being colored differently from others within the context of all available paths, executed and unexecuted, in workflow 114. In some other examples, execution path 502A-502D of each end-user 112A-112D is visualized in a separate one of workflow graph 120.

In some examples, each instance 408 is executed in a marketplace platform 506 in a production environment (e.g., without any restrictions to system level resources) whereas workflow graph 120 is visualized in a sandbox 508 in marketplace platform 506, as shown in FIG. 5B. Sandbox 508 facilitates executing workflow visualizer 100 in a secure environment that is isolated from the remainder of marketplace platform 506 (e.g., production environment) where other parts of tiered software framework 200 execute. Sandbox 508 remains segregated from through various means. For example, memory registers of sandbox 508 are abstracted and managed through the operating system or container runtime, preventing direct access to system-level memory or registers of marketplace platform 506. Access controls, namespaces, and other parameters limit resource usage and visibility to sandbox 508, while system calls from sandbox 508 to marketplace platform 506 are filtered through API 130 to prevent unsafe operations. Safety is ensured by combining these isolation techniques with strict network policies, filesystem mount restrictions (e.g., read-only or ephemeral storage), and constant monitoring. Any breach or anomaly in sandbox 508 can be detected and contained without compromising the integrity or security of production marketplace platform 506. In various examples, the boundaries of sandbox 508, including permitted API calls and network access, are set at tier 102-1, so that end-users 112 or users 116 cannot modify them to gain unauthorized access to other parts of tiered software framework 200 through workflow visualizer 100.

Note that sandbox 508 is not merely a testing environment; it is used during live production execution of workflow visualizer 100. Note also that sandbox 508 is different from a virtual execution container, the latter being a standalone executable package that includes everything needed to run a piece of software (e.g., code, runtime, libraries, and dependencies) using operating system (OS) level virtualization. While the container has OS level process isolation, sandbox 508 has code-level, API restrictions. In other words, sandbox 508 comprises a restricted execution space with access to a limited set of calls to API 130. Thus, executing in sandbox 508 ensures that data cannot be leaked (e.g., by writing to execution log 412 inadvertently) while instance 408 is simultaneously executing in marketplace platform 506.

As shown in FIG. 5C, user interface 126 displays workflow graph 120 as a hierarchical directed graph comprising nodes 122 (represented as rectangles) and edges 124 (represented as lines) coupled according to the configurations of workflow 114. Workflow visualizer 100 facilitates simultaneous display of execution paths 502 as well as errors 504 in workflow graph 120. In the example shown, workflow graph 120 comprises nodes 122(1)-122(9). Node 122(1) represents a condition for which two outcomes are possible, represented by nodes 122(2) and 122(3). Node 122(2) represents another condition for which three outcomes are possible, represented by nodes 122(4), 122(5) and 122(6).

Node 122(4) is followed by next action represented by node 122(7). Node 122(3) is followed by another action represented by node 122(8). Node 122(9) represents a discontinuity, i.e., a “go to” operation following completion of execution of node 122(8).

Each execution path 502 represents a sequential completion of the singular outcome of each condition. For example, in execution path 502A, node 122(2) is the outcome of the condition represented by node 122(1); node 122(4) is the outcome of the condition represented by node 122(2); and so on. Thus, execution path 502A comprises nodes 122(1), 122(2), 122(4) and 122(7). On the other hand, in execution path 502B, node 122(3) is the outcome of the condition represented by node 122(1), and thus execution path 502A bifurcates from execution path 502B after node 122(1). Further, execution of node 122(8) triggers a go-to discontinuity, adding node 122(9) to execution path 502B.

Consider an example scenario in which workflow 114 represents a contact form to be filled by end-user 112. Condition 122(1) presents two possible avenues: contact on social media, represented by node 122(2) and contact by phone, represented by node 122(3). End-user 112A selects contact on social media, represented by node 122(2), which triggers three possible outcomes: contact on Instagram™, represented by node 122(4), contact on Facebook™, represented by node 122(5), and contact on TikTok™, represented by node 122(6). End-user 112A selects contact on Instagram™, represented by node 122(4), leading to node 122(7), where end-user112A submits their Instagram™ handle. End-user 112D also chooses contact on Instagram™, represented by node 122(4), leading to node 122(7), where end-user 112D submits an incorrect Instagram™ handle, triggering error 504. End-user 112B, on the other hand, selects contact by phone, represented by node 122(3), and enters their phone number in node 122(8). Entering the phone number 122(8) triggers the “go to” operation, represented by node 122(9), at which end-user 112B consents to receiving text messages for which data rates may apply. Node 122(9) may be configured as a different portion of workflow 114, for example, consisting of various other consent pop-ups and legal agreements. Node 122(9) is called only when node 122(8) successfully executes. This sequence of completed actions is represented by execution path 502B. Various other such scenarios are contemplated within the broad scope of the disclosure.

In this example scenario, contact on Facebook™, represented by node 122(5), and contact on TikTok™, represented by node 122(6) remain unexecuted. Although they are unexecuted, they are also displayed in workflow graph 120 to facilitate faster and more effective troubleshooting and visualization. Thus, at one glance, it becomes clear that end-users 112 are not selecting to be contacted on Facebook™ or TikTok™. It is also clear that these are the alternative options available at node 122(2). It is also clarified visually made that end-user 112D encountered an error while entering their Instagram™ handle, enabling the application developer to diagnose the code at node 122(7) suitably. Such information is not available if only unexecuted workflow 114 is displayed as workflow graph 120, or only executed paths 502 are displayed as workflow graph 120. Displaying only workflow 114 without showing the execution paths 502 makes it tedious to determine at which node 122 error 504 occurred. Displaying only execution paths 502 without the context of the greater workflow does not provide a comprehensive picture; for example, the “go to” operation between nodes 122(8) and 122(9) may not be easily identifiable as a “go to”operation without the context of other parts of workflow 114.

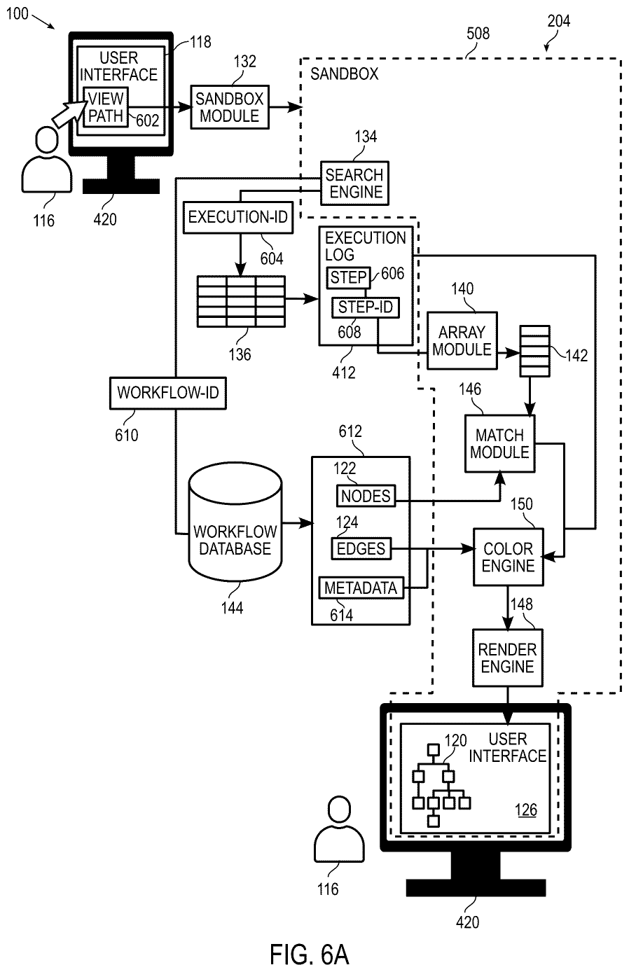

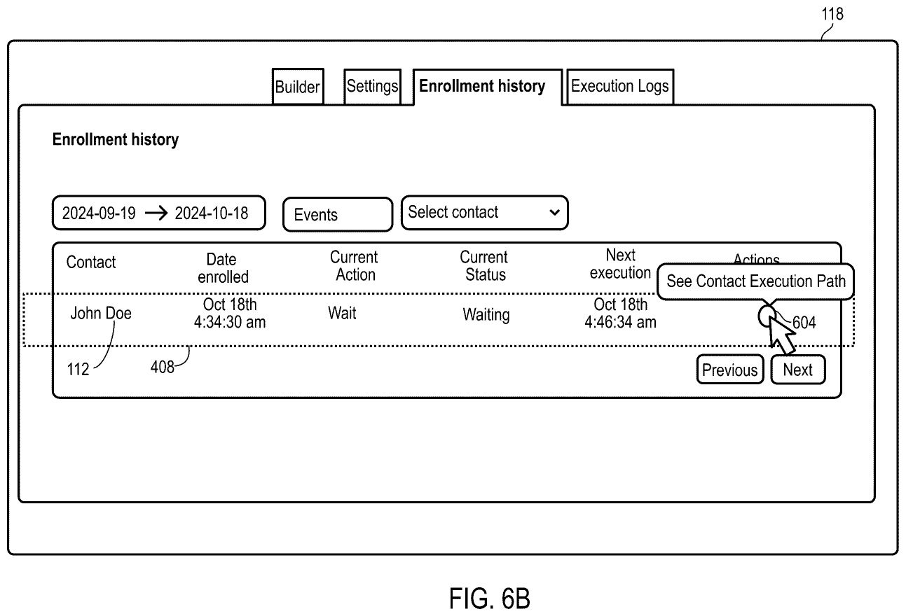

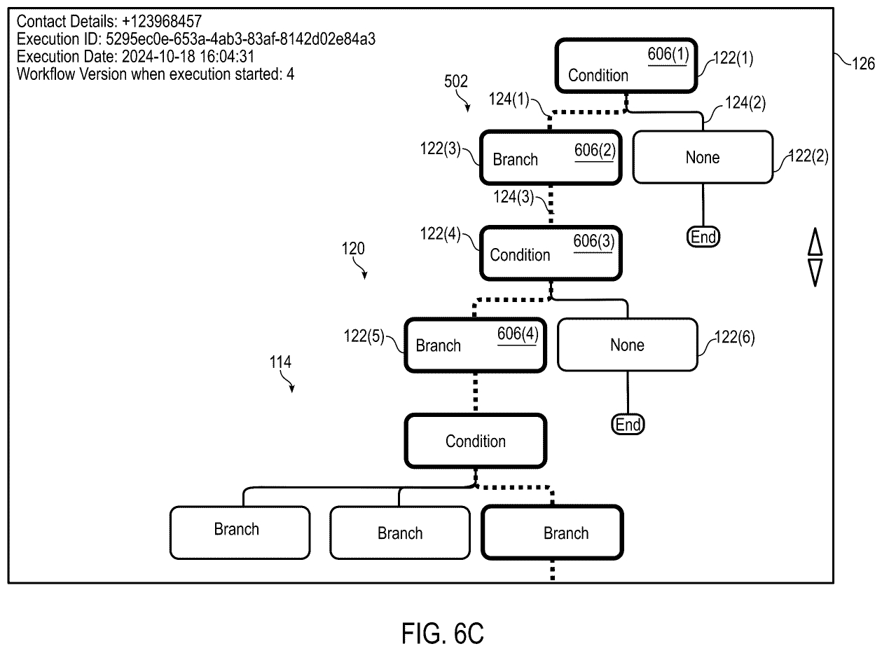

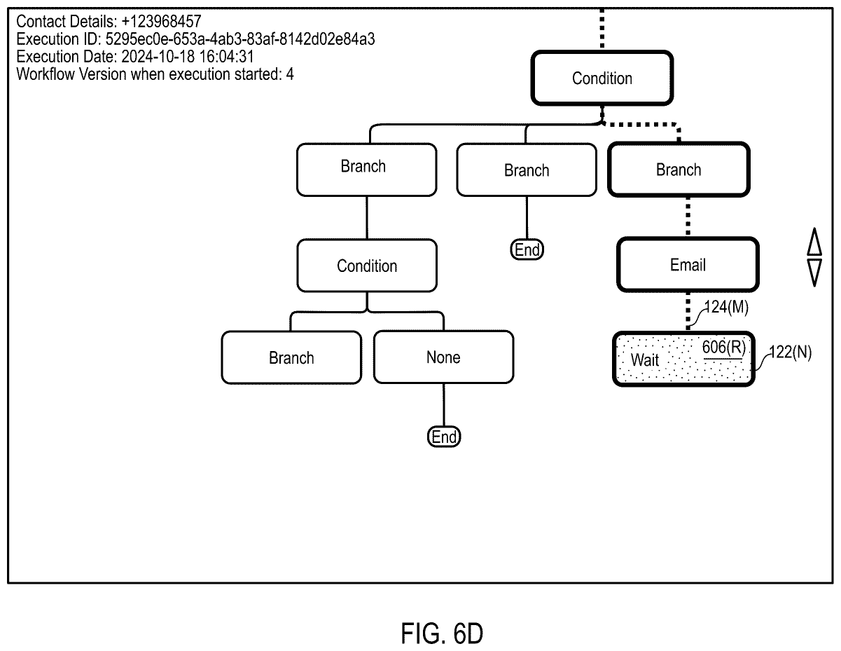

FIG. 6A is a simplified block diagram illustrating various example details of workflow visualizer 100. User 116 interacts with user interface 118 on computing device 420. As part of the interaction, user 116 selects a “view path” user interface element 602. An example of user interface 118 is shown in FIG. 6B. An example “view path” user interface element 602 comprises a selection button which displays a message, “See Contact Execution Path” when the mouse is hovered over the button. In the example shown, an “enrollment summary” window displays instances 408 of workflow 114 (and other workflows) executed in marketplace platform 506. For example, the displayed instance 408 indicates that end-user 112, named John Doe, executed workflow 114 and the status of execution is “Waiting. ”Other details such as execution time is also displayed. Note that the example view shows only one end-user 112; any number of instances 408 associated with any number of end-user 112 may be displayed in user interface 118 suitably.

Returning to FIG. 6A, selecting “view path” user interface element 602 invokes sandbox module 132, which instantiates sandbox 508 in another computing device, for example, one or more servers 204. Search engine 134 is invoked in sandbox 508. Using execution identifier 604, search engine 134 looks up execution log library 136 and fetches execution log 412 into sandbox 508. Execution log 412 includes various steps 606, representing executed nodes 122, each step 606 identified by a corresponding step identifier 608. Array module 140, invoked in sandbox 508, extracts step identifier 608 and stores it in step-ID array 142.

Search engine 134 also searches 144 using workflow identifier 610 that corresponds to a particular version of workflow 114 and fetches workflow data container 612 from workflow database 144 into sandbox 508. Workflow data container 612 includes information on nodes 122, edges 124 and metadata 614 of workflow 114. Match module 146 compares step identifier 608 of each node 122 in workflow data container 612 with each step identifier 608 stored in step-ID array 142. According to the results of the comparison, metadata 614 and status of each executed step 606, color engine 150, invoked in sandbox 508, assigns an appropriate color to nodes 122 and edges 124. Render engine 148, invoked in 508, thereafter renders workflow graph 120 in user interface 126 in computing device 420. In various examples, user interface 126 is invoked in sandbox 508 as described previously.

FIGS. 6C-6D are examples of user interface 126. The view shown in FIG. 6D is a continuation of the view shown in FIG. 6C. In the example shown, user interface 126 is scrollable up or down, or right or left, to display workflow 114 in its entirety. Workflow graph 120 is displayed as a hierarchical directed graph in the example, with nodes 122(1)-122(N) and edges 124(1)-124(M) displayed in one color (as indicated by regular strokes and continuous lines) and executed path 502 with steps 606(1)-606(R) displayed in another color (as indicated by bold strokes and dotted lines). Step 606 indicates an executed state of node 122. In some examples, an error may be indicated in a different color, as shown by the dotted box corresponding to node 122(N), representing step 606(R). Note that not all nodes and edges are labeled merely to ease clutter in the drawing.

Execution log 412 of execution paths 502 indicates the status of each step 606 (e.g., completed, error) but does not include information on unexecuted nodes 122 of workflow 114. On the other hand, workflow data container 612 includes information of various nodes 122 and edges 124, but does not include execution status of executed steps 606. Workflow visualizer 100 combines information from two disparate sources, namely execution log 412 and workflow data container 612, in a visually compelling and easy to understand manner in workflow graph 120.

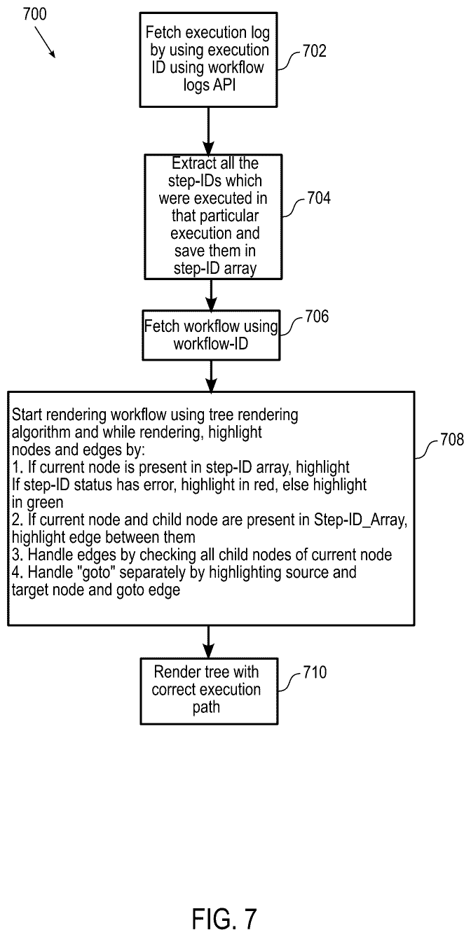

FIG. 7 is a simplified flow diagram illustrating example operations 700 that are associated with workflow visualizer 100. At 702, execution log 412 is fetched by using execution identifier 604 using a workflow logs API instruction through API 130. At 704, step identifiers 608 of all steps 606 which were executed in that particular execution are extracted and stored in step-ID array 142. At 706, information on workflow 114 as represented by workflow data container 612 is fetched using workflow identifier 610. At 708, render engine 148 starts rendering workflow 114 using a tree rendering algorithm and while rendering, highlights nodes 122 and edges 124 as follows. If current node 122 (i.e., node being rendered) is present in step-ID array 142, highlight current node 122 (e.g., by green color). If status in execution log 412 indicates error, highlight current node 122 in red color. If step identifiers 608 of both current node 122 and child node are present in step-ID array 142, edge 124 between them is highlighted (e.g., in green dotted line). Edges 124 are handled by checking the child nodes of current node 122. Discontinuities such as “goto” are handled separately by highlighting source node and target node and the goto edge separately. At 710, the tree with correct execution path finishes rendering in user interface 126.

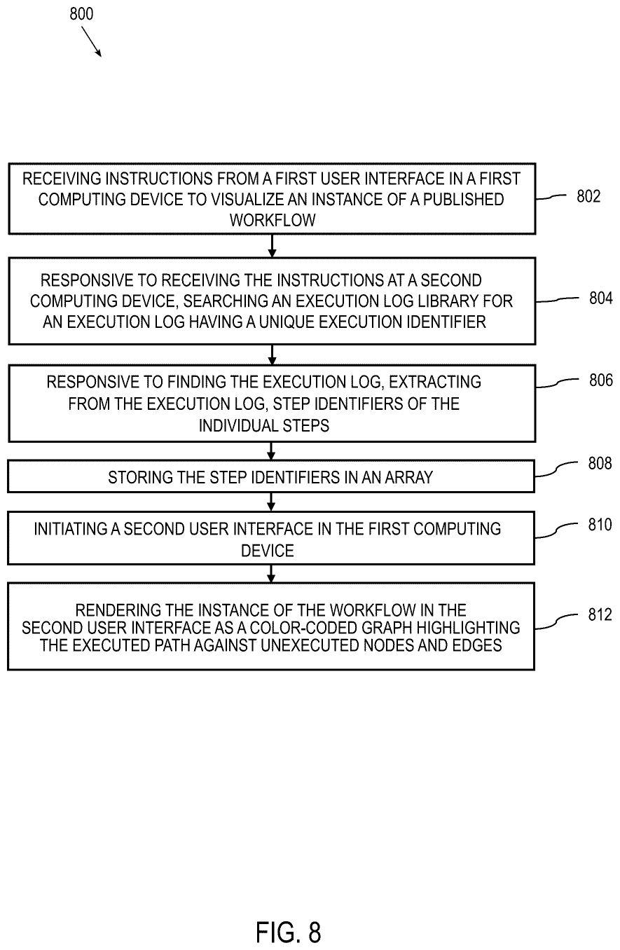

FIG. 8 is a simplified flow diagram illustrating example operations 800 that are associated with workflow visualizer 100. At 802, instructions are received from user interface 118 in computing device 420 to visualize instance 408 of published workflow 114. At 804, responsive to receiving the instructions at another computing device 204, execution log library 136 is searched for execution log 412 having unique execution identifier 604. At 806, responsive to finding execution log 412, step identifiers 608 of individual steps 606 are extracted from execution log 412. At 808, step identifiers 608 are stored in step-ID array 142. At 810, another user interface 126 is initiated in computing device 420. At 812, responsive to initiating user interface 126, instance 408 of workflow 114 is rendered in user interface 126 as a color-coded graph highlighting executed path 502 against unexecuted nodes 122 of workflow 114.

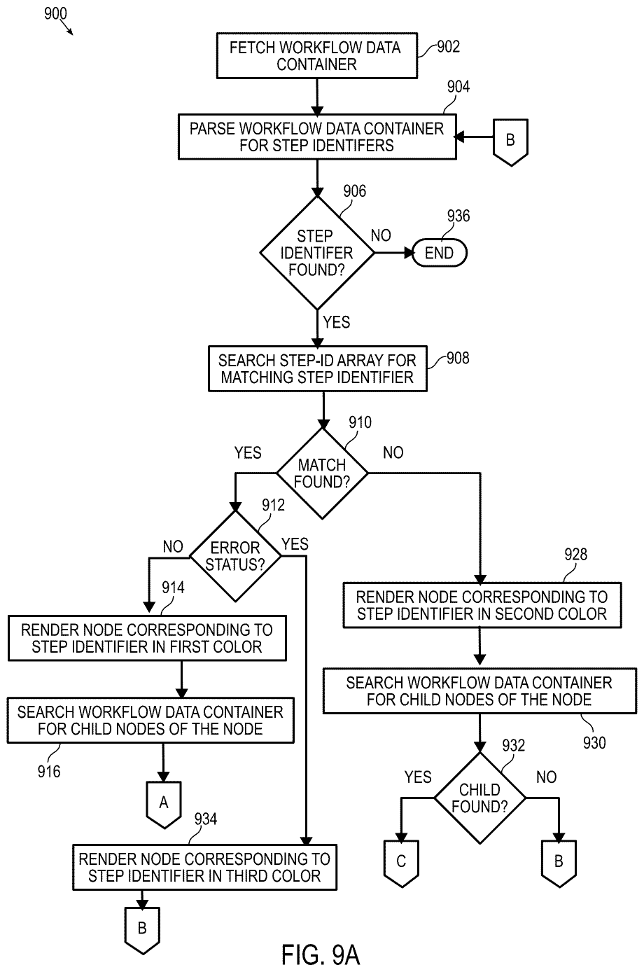

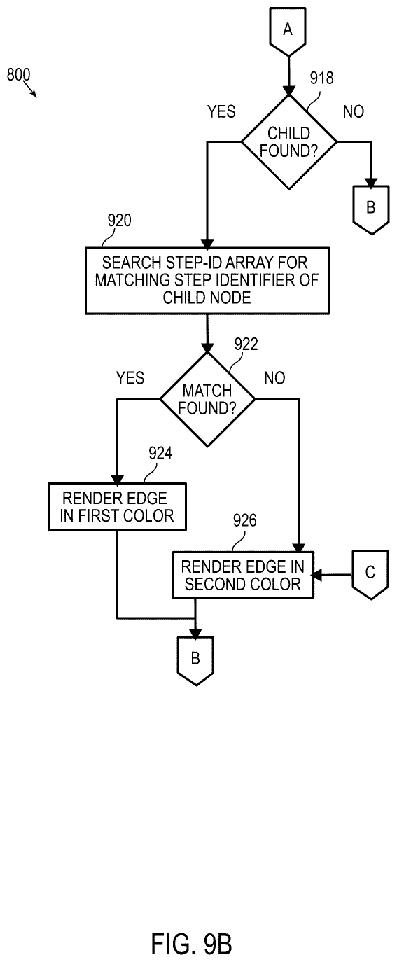

FIGS. 9A and 9B are simplified flow diagrams illustrating example operations 900 associated with rendering workflow graph 120 in user interface 126. In various examples, at least some portion of operations 900 describe an example implementation of operation 812. At 902, workflow data container 612 is fetched from workflow database 144. at 904, workflow data container 612 is parsed for step identifiers 608. At 906, a determination is made whether any step identifiers 608 is found. If found, at 908, step-ID array 142 is searched for a matching one of step identifiers 608. At 910 a determination is made whether a match is found. If a match is found, at 912, a determination is made if a status of step 606 having step identifier 608 shows an error. If no error is found, at 914, node 122 corresponding to step identifier 608 is rendered in a first color. At 916, workflow data container 612 is searched for child nodes of node 122 being rendered. As continued in FIG. 9B, at 918, a determination is made if a child node is found. If a child node is found, at 920, step-ID array 142 is searched for the matching step identifier of the child node. At 922, a determination is made whether a match is found. If the match is found, at 924, edge 124 between the node and the child node is rendered in the first color. If the match is not found, at 926, edge 124 between node 122 and the child node is rendered in a second color. The operations revert to 904 in FIG. 9A, and continue thereafter until all nodes of workflow 114 in workflow data container 612 have been rendered.

Turning to operation 910, if a match for step identifiers 608 of the current node being rendered is not found in step-ID array 142, at 928, the current node is rendered in the second color. At 930, workflow data container 612 is searched for child nodes of the current node. At 932, a determination is made whether a child node is found. If a child node is found, the operations step to 926, at which edge 124 between the child node and the current node is rendered in the second color. If a child node is not found, the operations revert to 904 in FIG. 9A, and continue thereafter until all nodes of workflow 114 in workflow data container 612 have been rendered.

Turning to operation 912, if the status of execution of the current node being rendered shows error, at 934, the current node is rendered in a third color. The operations revert to 904, and continue thereafter until all nodes of workflow 114 in workflow data container 612 have been rendered. Turning to operation 906, if all step identifiers 608 of all nodes 122 in workflow data container 612 have completed analysis, the operations come to an end at 936.

In various embodiments, substantially most operations described in the various figures are performed automatically without human intervention. Although the figures illustrate various operations performed in a particular order, this is simply illustrative, and the operations discussed herein may be reordered and/or repeated as suitable. Further, additional operations which are not illustrated may also be performed without departing from the scope of the present disclosure. Also, various ones of the operations discussed herein with respect to the figures may be modified in accordance with the present disclosure to automatically build workflows as disclosed herein. Although various operations are illustrated in the figures once each, the operations may be repeated as often as desired.

It is important to note that the operations described with reference to the preceding figures illustrate only some of the possible scenarios that may be executed by, or within, the workflow builder Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion.

### Examples

Example 1 provides a method for visualizing workflows in a tiered software framework, the method comprising: receiving instructions from a first user interface in a first computing device to visualize an instance of a published workflow, wherein: the instructions are received at a second computing device, the instance at least partially completed execution, the instance is identified by a unique execution identifier, and the workflow is represented in a data container identified by a unique workflow identifier, the data container comprising at least nodes identified by respective unique step identifiers and edges representing dependencies between the nodes; responsive to receiving the instructions at the second computing device, searching an execution log library for an execution log associated with the unique execution identifier, wherein: the execution log comprises status of individual steps of the workflow completed during execution of the instance, and the execution log library is configured for inverted indexing; responsive to finding the execution log, extracting step identifiers of the individual steps from the execution log, and storing the step identifiers in an array; initiating a second user interface in the first computing device; and automatically rendering the instance of the workflow in the second user interface as a color-coded graph highlighting an executed path of the instance against unexecuted nodes and edges of the workflow.

Example 2 provides the method of example 1, wherein the rendering comprises, for each node in the workflow: parsing the array for the corresponding step identifier; responsive to finding the step identifier in the array, rendering the node in a first color; responsive to not finding the step identifier in the array, rendering the node in a second color; and responsive to finding the step identifier and another step identifier corresponding to another node in the array, and determining that an edge between the node and the another node is a parent-child dependency, rendering the edge in the first color.

Example 3 provides the method of example 2, further comprising:

responsive to identifying a discontinuity in the workflow represented by a “go to” condition: identifying a source node and a destination node of the discontinuity, and rendering the workflow with another edge connecting the source node and the destination node.

Example 4 provides the method of example 2, further comprising, responsive to finding that the status of the step identifier in the workflow execution log indicates an error, rendering the node in a third color.

Example 5 provides the method of example 1, further comprising, responsive to receiving the instructions, instantiating a sandbox in the second computing device, wherein: the array is stored in the sandbox, and the second user interface is rendered in the sandbox.

Example 6 provides the method of example 5, further comprising: responsive to instantiating the sandbox, searching a workflow database for the data container associated with the workflow identifier; responsive to finding the data container, analyzing the nodes in the data container against the step identifiers in the array.

Example 7 provides the method of example 1, wherein: the tiered software framework comprises a first tier, a second tier, and a third tier, the first tier is upstream from the second tier and the third tier, and the third tier is downstream from the first tier and the second tier, and data access among the first tier, the second tier and the third tier is governed by data access policies, such that upstream data is not accessible by downstream tiers and downstream data is accessible by upstream tiers.

Example 8 provides the method of example 1, wherein: the execution log comprises text including searchable tokens, and the searchable tokens are mapped to corresponding execution logs in which they appear.

Example 9 provides non-transitory computer-readable tangible media that includes instructions for execution, which when executed by a processor of a computing device, is operable to perform operations comprising: receiving instructions from a first user interface in a first computing device to visualize an instance of a published workflow, wherein: the instructions are received at a second computing device, the instance at least partially completed execution, the instance is identified by a unique execution identifier, and the workflow is represented in a data container identified by a unique workflow identifier, the data container comprising at least nodes identified by respective unique step identifiers and edges representing dependencies between the nodes; responsive to receiving the instructions at the second computing device, searching an execution log library for an execution log associated with the unique execution identifier, wherein: the execution log comprises status of individual steps of the workflow completed during execution of the instance, and the execution log library is configured for inverted indexing; responsive to finding the execution log, extracting step identifiers of the individual steps from the execution log, and storing the step identifiers in an array; initiating a second user interface in the first computing device; and automatically rendering the instance of the workflow in the second user interface as a color-coded graph highlighting an executed path of the instance against unexecuted nodes and edges of the workflow.

Example 10 provides the non-transitory computer-readable tangible media of example 9, wherein the rendering comprises, for each node in the workflow: parsing the array for the corresponding step identifier; responsive to finding the step identifier in the array, rendering the node in a first color; responsive to not finding the step identifier in the array, rendering the node in a second color; and responsive to finding the step identifier and another step identifier corresponding to another node in the array, and determining that an edge between the node and the another node is a parent-child dependency, rendering the edge in the first color.

Example 11 provides the non-transitory computer-readable tangible media of example 10, the operations further comprising: responsive to identifying a discontinuity in the workflow represented by a “go to” condition: identifying a source node and a destination node of the discontinuity; and rendering the workflow with another edge connecting the source node and the destination node.

Example 12 provides the non-transitory computer-readable tangible media of example 10, wherein the operations further comprise: responsive to finding that the status of the step identifier in the workflow execution log indicates an error, rendering the node in a third color.

Example 13 provides the non-transitory computer-readable tangible media of example 9, wherein the operations further comprise: responsive to receiving the instructions, instantiating a sandbox in the second computing device, wherein: the array is stored in the sandbox, and the second user interface is rendered in the sandbox.

Example 14 provides the non-transitory computer-readable tangible media of example 13, wherein the operations further comprise: responsive to instantiating the sandbox, searching a workflow database for the data container associated with the workflow identifier; and responsive to finding the data container, analyzing the nodes in the data container against the step identifiers in the array.

Example 15 provides an apparatus comprising: a processing circuitry; a memory storing data; and a communication circuitry, wherein the processing circuitry executes instructions associated with the data, the processing circuitry is coupled to the communication circuitry and the memory, and the processing circuitry and the memory cooperate, such that the apparatus is configured for: receiving instructions from a first user interface in a computing device to visualize an instance of a published workflow, wherein: the instructions are received at the apparatus, the instance at least partially completed execution, the instance is identified by a unique execution identifier, and the workflow is represented in a data container identified by a unique workflow identifier, the data container comprising at least nodes identified by respective unique step identifiers and edges representing dependencies between the nodes; responsive to receiving the instructions, searching an execution log library for an execution log associated with the unique execution identifier, wherein: the execution log comprises status of individual steps of the workflow completed during execution of the instance, and the execution log library is configured for inverted indexing; responsive to finding the execution log, extracting step identifiers of the individual steps from the execution log, and storing the step identifiers in an array; initiating a second user interface in the computing device; and automatically rendering the instance of the workflow in the second user interface as a color-coded graph highlighting an executed path of the instance against unexecuted nodes and edges of the workflow.

Example 16 provides the apparatus of example 15, wherein the rendering comprises, for each node in the workflow: parsing the array for the corresponding step identifier; responsive to finding the step identifier in the array, rendering the node in a first color; responsive to not finding the step identifier in the array, rendering the node in a second color; and responsive to finding the step identifier and another step identifier corresponding to another node in the array, and determining that an edge between the node and the another node is a parent-child dependency, rendering the edge in the first color.

Example 17 provides the apparatus of example 16, further configured for: responsive to identifying a discontinuity in the workflow represented by a “go to” condition: identifying a source node and a destination node of the discontinuity; and rendering the workflow with another edge connecting the source node and the destination node.

Example 18 provides the apparatus of example 16, further configured for: responsive to finding that the status of the step identifier in the workflow execution log indicates an error, rendering the node in a third color.

Example 19 provides the apparatus of example 15, further configured for: responsive to receiving the instructions, instantiating a sandbox in the second computing device, wherein: the array is stored in the sandbox, and the second user interface is rendered in the sandbox.

Example 20 provides the apparatus of example 19, further configured for: responsive to instantiating the sandbox, searching a workflow database for the data container associated with the workflow identifier; and responsive to finding the data container, analyzing the nodes in the data container against the step identifiers in the array.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

1. A method for visualizing workflows in a tiered software framework, the method comprising:
receiving instructions from a first user interface in a first computing device to visualize an instance of a published workflow, wherein:
the instructions are received at a second computing device,
the instance at least partially completed execution,
the instance is identified by a unique execution identifier, and
the workflow is represented in a data container identified by a unique workflow identifier, the data container comprising at least nodes identified by respective unique step identifiers and edges representing dependencies between the nodes;
responsive to receiving the instructions at the second computing device, searching an execution log library for an execution log associated with the unique execution identifier, wherein:
the execution log comprises status of individual steps of the workflow completed during execution of the instance, and
the execution log library is configured for inverted indexing;
responsive to finding the execution log, extracting step identifiers of the individual steps from the execution log, and storing the step identifiers in an array;
initiating a second user interface in the first computing device; and
automatically rendering the instance of the workflow in the second user interface as a color-coded graph highlighting an executed path of the instance against unexecuted nodes and edges of the workflow.

2. The method of claim 1, wherein the rendering comprises, for each node in the workflow identified by a step identifier:
parsing the array for the step identifier;
responsive to finding the step identifier in the array, rendering the node in a first color;
responsive to not finding the step identifier in the array, rendering the node in a second color; and
responsive to finding the step identifier and another step identifier corresponding to another node in the array, and determining that an edge between the node and the another node is a parent-child dependency, rendering the edge in the first color.

3. The method of claim 2, further comprising:
responsive to identifying a discontinuity in the workflow represented by a “go to” condition:
identifying a source node and a destination node of the discontinuity; and
rendering the workflow with another edge connecting the source node and the destination node.

4. The method of claim 2, further comprising, responsive to finding that the status of the step identifier in the workflow execution log indicates an error, rendering the node in a third color.

5. The method of claim 1, further comprising:
responsive to receiving the instructions, instantiating a sandbox in the second computing device, wherein:
the array is stored in the sandbox, and
the second user interface is rendered in the sandbox.

6. The method of claim 5, further comprising:
responsive to instantiating the sandbox, searching a workflow database for the data container associated with the workflow identifier; and
responsive to finding the data container, analyzing the nodes in the data container against the step identifiers in the array.

7. The method of claim 1, wherein:
the tiered software framework comprises a first tier, a second tier, and a third tier,
the first tier is upstream from the second tier and the third tier, and the third tier is downstream from the first tier and the second tier, and
data access among the first tier, the second tier and the third tier is governed by data access policies, such that upstream data is not accessible by downstream tiers and downstream data is accessible by upstream tiers.

8. The method of claim 1, wherein:
the execution log comprises text including searchable tokens, and
the searchable tokens are mapped to corresponding execution logs in which they appear.

9. Non-transitory computer-readable tangible media that includes instructions for execution, which when executed by a processor of a computing device, is operable to perform operations comprising:
receiving instructions from a first user interface in a first computing device to visualize an instance of a published workflow, wherein:
the instructions are received at a second computing device,
the instance at least partially completed execution,
the instance is identified by a unique execution identifier, and
the workflow is represented in a data container identified by a unique workflow identifier, the data container comprising at least nodes identified by respective unique step identifiers and edges representing dependencies between the nodes;
responsive to receiving the instructions at the second computing device, searching an execution log library for an execution log associated with the unique execution identifier, wherein:
the execution log comprises status of individual steps of the workflow completed during execution of the instance, and
the execution log library is configured for inverted indexing;
responsive to finding the execution log, extracting step identifiers of the individual steps from the execution log, and storing the step identifiers in an array;
initiating a second user interface in the first computing device; and
automatically rendering the instance of the workflow in the second user interface as a color-coded graph highlighting an executed path of the instance against unexecuted nodes and edges of the workflow.

10. The non-transitory computer-readable tangible media of claim 9, wherein the rendering comprises, for each node in the workflow identified by a step identifier:
parsing the array for the step identifier;
responsive to finding the step identifier in the array, rendering the node in a first color;
responsive to not finding the step identifier in the array, rendering the node in a second color; and
responsive to finding the step identifier and another step identifier corresponding to another node in the array, and determining that an edge between the node and the another node is a parent-child dependency, rendering the edge in the first color.

11. The non-transitory computer-readable tangible media of claim 10, the operations further comprising: responsive to identifying a discontinuity in the workflow represented by a “go to” condition:
identifying a source node and a destination node of the discontinuity; and
rendering the workflow with another edge connecting the source node and the destination node.

12. The non-transitory computer-readable tangible media of claim 10, wherein the operations further comprise: responsive to finding that the status of the step identifier in the workflow execution log indicates an error, rendering the node in a third color.

13. The non-transitory computer-readable tangible media of claim 9, wherein the operations further comprise:
responsive to receiving the instructions, instantiating a sandbox in the second computing device, wherein:
the array is stored in the sandbox, and
the second user interface is rendered in the sandbox.

14. The non-transitory computer-readable tangible media of claim 13, wherein the operations further comprise:
responsive to instantiating the sandbox, searching a workflow database for the data container associated with the workflow identifier; and
responsive to finding the data container, analyzing the nodes in the data container against the step identifiers in the array.

15. An apparatus comprising:
a processing circuitry;
a memory storing data; and
a communication circuitry, wherein the processing circuitry executes instructions associated with the data, the processing circuitry is coupled to the communication circuitry and the memory, and the processing circuitry and the memory cooperate, such that the apparatus is configured for:
receiving instructions from a first user interface in a computing device to visualize an instance of a published workflow, wherein:
the instructions are received at the apparatus,
the instance at least partially completed execution,
the instance is identified by a unique execution identifier, and
the workflow is represented in a data container identified by a unique workflow identifier, the data container comprising at least nodes identified by respective unique step identifiers and edges representing dependencies between the nodes;
responsive to receiving the instructions, searching an execution log library for an execution log associated with the unique execution identifier, wherein:
the execution log comprises status of individual steps of the workflow completed during execution of the instance, and
the execution log library is configured for inverted indexing;
responsive to finding the execution log, extracting step identifiers of the individual steps from the execution log, and storing the step identifiers in an array;
initiating a second user interface in the computing device; and
automatically rendering the instance of the workflow in the second user interface as a color-coded graph highlighting an executed path of the instance against unexecuted nodes and edges of the workflow.

16. The apparatus of claim 15, wherein the rendering comprises, for each node in the workflow identified by a step identifier:
parsing the array for the step identifier;
responsive to finding the step identifier in the array, rendering the node in a first color;
responsive to not finding the step identifier in the array, rendering the node in a second color; and
responsive to finding the step identifier and another step identifier corresponding to another node in the array, and determining that an edge between the node and the another node is a parent-child dependency, rendering the edge in the first color.

17. The apparatus of claim 16, further configured for:
responsive to identifying a discontinuity in the workflow represented by a “go to” condition:
identifying a source node and a destination node of the discontinuity; and
rendering the workflow with another edge connecting the source node and the destination node.

18. The apparatus of claim 16, further configured for: responsive to finding that the status of the step identifier in the workflow execution log indicates an error, rendering the node in a third color.

19. The apparatus of claim 15, further configured for:
responsive to receiving the instructions, instantiating a sandbox in the second computing device, wherein:
the array is stored in the sandbox, and
the second user interface is rendered in the sandbox.

20. The apparatus of claim 19, further configured for:
responsive to instantiating the sandbox, searching a workflow database for the data container associated with the workflow identifier; and
responsive to finding the data container, analyzing the nodes in the data container against the step identifiers in the array.
